(19) United States
(12) Patent Application Publication
(10) Pub. No.: US 2007/0098270 A1
(43) Pub. Date: May 3, 2007

(54) Device storing vector image with handles identifying portions of the device, and methods and computer programs to aid in mapping or correlating portions of an image retrieved from a device with portions of the device

(76) Inventors: Andrew Christopher Walton, Rocklin, CA (US); Bryan J. Jacquot, Windsor, CO (US); Steve Lyle, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/260,993

(22) Filed: Oct. 27, 2005

(51) Int. Cl. G06K 9/36

(52) U.S. Cl. 382/232

(57) ABSTRACT

In one embodiment, a device is provided with a non-volatile memory in which a vector image illustrating the device is stored, and an interface to provide a remote management tool with access to the vector image, to assist the tool in managing the device. The vector image has a plurality of vectors, with one or more sets of the vectors being associated with one or more handles. Each of the handles identifies a portion of the device. Methods for generating and embedding the vector image in the device, and programs that access the device and utilize the relationships between the image's handles and vectors, are also disclosed.

### Background

The management of a device is typically aided by providing its user with a means to graphically visualize the device. In some cases, one or more images of a device and its components may be included within paper or electronic documentation (e.g., a user manual). In other cases, a device may be provided with stickers showing one or more views of the device's interior components.

In still other cases, images of a device may be incorporated into a management tool for the device. For example, a print driver may display an image of the printer to which it corresponds, or a server management tool may display various images associated with the server components of which the management tool is aware or can manage (e.g., the server's memory modules, interfaces, or storage disks).

Many devices for which graphical images are needed are subject to change. That is, the devices may be upgradeable such that additional components (e.g., memory modules, interfaces, or storage disks) may be inserted into or attached to the device. Thus, an issue facing the image creator is whether to draw an image of each configuration of the device or draw a single “exemplary” image in which the device is depicted in one particular “default” configuration.

A device may also be subject to change over its lifecycle. That is, the styling of the device's exterior, the suppliers of its internal components, its “default” configuration, and even its available features can change over its lifecycle. Thus, any images pertaining to the first generation of the device may not accurately depict later generations of the device.

As one can appreciate, the creation and maintenance of graphical images for a device can present a significant burden for both device manufacturers and third-party device supporters (e.g., management tool developers).

### SUMMARY OF THE INVENTION

In one embodiment, a device comprises a non-volatile memory in which a vector image illustrating the device is stored. The vector image comprises a plurality of vectors, with one or more sets of the vectors being associated with one or more handles. Each of the handles identifies a portion of the device. The device also comprises an interface to provide a remote management tool with access to the vector image, to assist the tool in managing the device.

In another embodiment, a computer program comprises code to, in response to receiving an image request, 1) retrieve a vector image from a device that is a target of the image request, and 2) display the vector image a user. The program also comprises code to, in response to the user's interaction with a portion of the displayed vector image, map coordinates of the user's interaction to one or more vectors of the vector image and return a handle that 1) is associated with the one or more vectors, and 2) identifies a portion of the device.

In yet another embodiment, a computer program comprises code to, in response to receiving an image request, 1) retrieve a vector image from a device that is a target of the image request, and 2) display the vector image to a user. The program also comprises 1) code to correlate a received handle representing a portion of the device to one or more vectors that are associated with the handle within the vector image, and 2) in response to an action associated with the received handle, format the vector image displayed to the user.

In another embodiment, an article of manufacture comprises computer-readable media, and computer-readable code that is stored on the computer-readable media. The computer-readable code includes code to, in response to receiving an image request, 1) retrieve a vector image from a device that is a target of the image request, and 2) display the vector image to a user. The computer-readable code also comprises 1) code to correlate a received handle representing a portion of the device to one or more vectors that are associated with the handle within the vector image, and 2) in response to an action associated with the received handle, format the vector image displayed to the user.

In an additional embodiment, a method for generating images of managed devices comprises generating at least one vector image illustrating each of the managed devices. The one or more handles are then embedded in the vector images. Each of the handles is associated with a plurality of vectors that define a portion of the device which the vector image illustrates. Embedded handles corresponding to similarly managed portions of different devices are similar.

Other embodiments are also disclosed.

### BRIEF DESCRIPTION OF THE DRAWINGS

Illustrative embodiments of the invention are illustrated in the drawings, in which:

FIG. 1 illustrates an exemplary device having a vector image embedded therein;

FIG. 2 illustrates an exemplary graphical representation of the vector image that is embedded in the FIG. 1 device;

FIG. 3 illustrates an exemplary textual representation of the vector image that is embedded in the FIG. 1 device;

FIG. 4 illustrates an exemplary computer program for returning a handle associated with a portion of a device with which a user interacts;

FIG. 5 illustrates an exemplary computer program for formatting a vector image displayed to a user; and

FIG. 6 illustrates an exemplary method for generating images of managed devices.

### DETAILED DESCRIPTION

One development that has eased the burden of creating and maintaining graphical images for a device is the electronic storage of a device's images within the device itself. For example, different images pertaining to different views and/or components of a device may be saved as Scalable Vector Graphics (SVG) files, or as other easy-to-manipulate files, and stored within a non-volatile memory of the device. Thus, a management tool for the device no longer needs to provide its own set of images for the device. Rather, the management tool need only be provided with abilities to 1) query the device to retrieve its image set, and 2) format one of the images to reflect the current state of the device. In this manner, the developer of the management tool need not be concerned with how the device looks, and can instead focus on how the device functions and is managed.

In some cases, it may be desirable to correlate portions of an image retrieved from a device with various portions (e.g., areas or components) of the device. For example, when a user interacts with a portion of a displayed image, the user's interaction may need to be mapped to a portion of the device, thereby enabling a management tool to determine how a user is interacting with the image. Or, for example, when a management tool determines that the status of a portion of the device has changed, the management tool may need to determine what portion of a device image corresponds to the device portion so that the image may be formatted to reflect the status change. In this regard, methods and apparatus that may be used to correlate portions of an image retrieved from a device with various portions of the device are disclosed below.

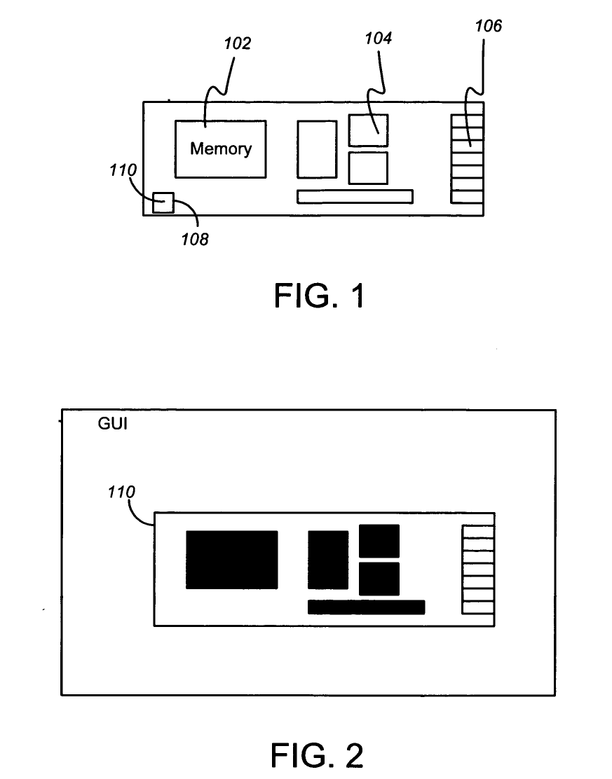

FIG. 1 illustrates an exemplary device 100. By way of example, the device 100 is shown to be a motherboard comprising a memory bank 102, a processor 104, and an interface 106. However, the methods and apparatus disclosed herein may be applied to any device, including those that form components of systems (such as the motherboard 100, an accessory card, or a memory module), and those that are fully functional systems and possibly contain other devices (e.g., servers, storage devices, printers or facsimile machines).

Stored within a non-volatile memory of the device 100 is a vector image 110 (or set of images) that illustrates the device 100. In one embodiment, the vector image 110 is a Scalable Vector Graphics (SVG) or other (eXtensible Markup Language) XML-based image. However, the image could take other forms, such as that of a postscript image.

The memory that stores the vector image 110 may be a memory that is used for other functions of the device 100 (e.g., the memory 102), or a memory 108 that is dedicated to storing images of the device 100 or providing some subset of functionality for the device 100.

The device 100 also comprises an interface to provide a remote management tool with access to the vector image 110, to assist the tool in managing the device. In some cases, the interface may be an interface that is used for other functions of the device 100 (e.g., the interface 106), and in other cases, the interface may be a dedicated interface (not shown).

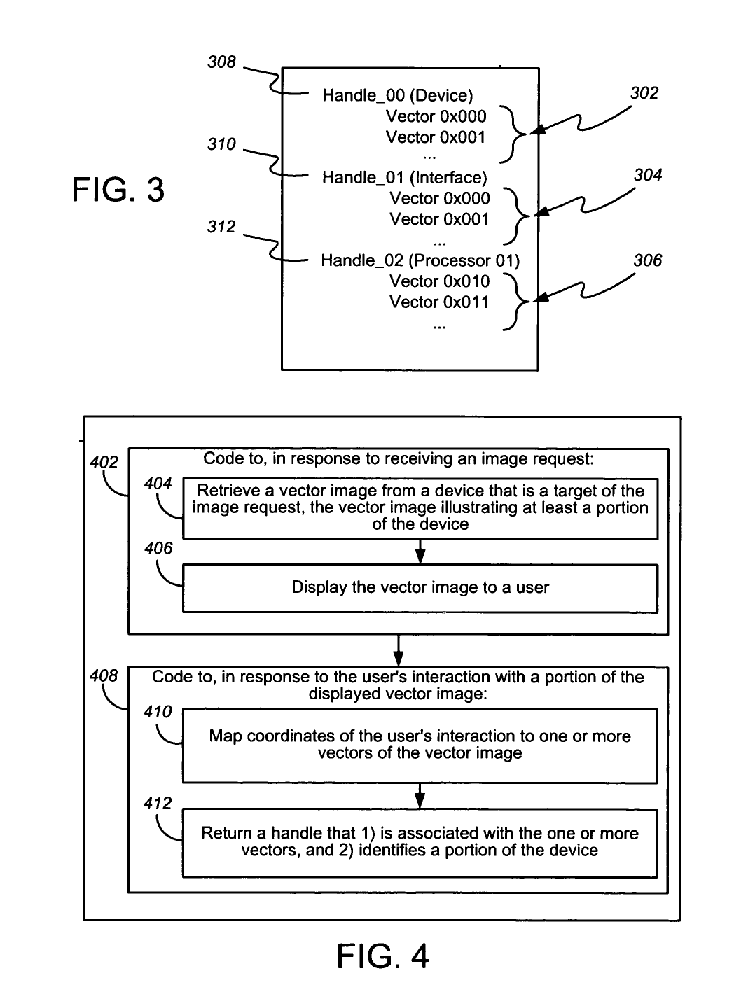

FIG. 2 illustrates an exemplary graphical representation 200 of the vector image 110; and FIG. 3 illustrates an exemplary textual representation 300 of the vector image 110. As shown in the textual representation 300, the vector image 110 comprises a plurality of vectors, one or more sets 302, 304, 306 of which are associated with one or more handles 308, 310, 312. In FIG. 3, the vectors are represented by references such as “Vector 0x000”. In practice, however, each vector will define how to draw a portion of the device 100. The handles are represented by references such as “Handle_{—}00”. In the image 110, “Handle_{—}00” identifies vectors that illustrate the device 100 as a whole, “Handle_{—}01” identifies vectors that illustrate the interface 106 of the device 100, and “Handle_{—}02” identifies vectors that illustrate the processor 104 of the device 100.

As needed, handles may identify discrete components of a device, or subparts or groups thereof. Preferably, the handles 308, 310, 312 are unique identifiers of portions, components, or groups of elements of the device 100. In the latter case, handles may have a first portion that identifies a component of a device as, for example, a DIMM, CPU or I/O card. A second portion of the handle can then uniquely identify the particular DIMM, CPU or I/O card.

The handles may be textual and/or numeric. In one embodiment, the handles comprise addresses of components of the device, such as physical addresses (e.g., bay or slot addresses), logical addresses (e.g., partition, segment or port addresses), or a combination thereof. In some cases, the addresses may be “physical locations” (e.g., 0xffffffffff02ff11), as used by currently available device management tools offered by the Hewlett-Packard Company.

FIG. 4 illustrates an exemplary computer program 400 for returning a handle associated with a portion of a device with which a user interacts. The program 400 comprises code 402 to, in response to receiving an image request, 1) retrieve 404 a vector image from the device that is the target of the image request, and then 2) display 406 the vector image to a user. The program 400 also comprises code 408 to, in response to the user's interaction with a portion of the displayed vector image, map 410 coordinates of the user's interaction (e.g., a mouse click, a mouse hover, or some other mouse or other interaction with the displayed image) to one or more vectors of the vector image. Code 412 then returns a handle that 1) is associated with the one or more vectors, and 2) identifies a portion of the device. In this manner, a device management tool may use the returned handle to determine how the user is interacting with the displayed image of the device. The management tool may then perform an action consonant with the interaction (e.g., an update of the image, an operation on the device, or the issuance of another image request).

In some cases, the program 400 may be incorporated into a particular device management tool. In other cases, the program 400 may be maintained apart from any particular device management tool (e.g., within an image processing utility) and may be accessed by various device management tools. By way of example, the “utility” may take the form of an application or browsers plug-in.

In some cases, each access of a vector image may be made by retrieving the image directly from the device in which it is stored. In other cases, the program 400 may comprise code to store a retrieved vector image in off-device storage. In this latter case, the code 408 to map coordinates of a user's interaction and return a handle may access the vector image stored in the off-device storage. In this manner, network traffic as a result of accessing the device, and unnecessary processing burdens on the device, may be avoided.

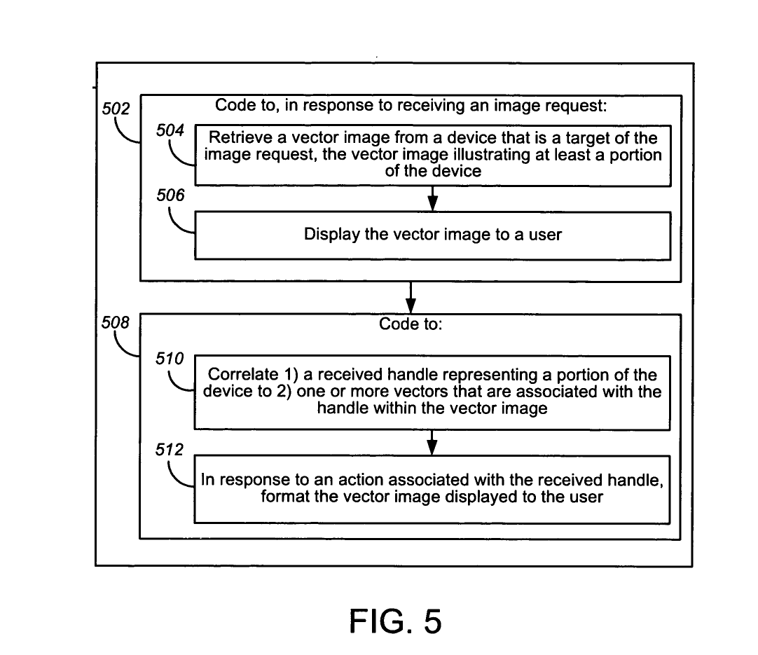

FIG. 5 illustrates an exemplary computer program 500 for formatting a vector image displayed to a user. The program 500 comprises code 502 to, in response to receiving an image request, 1) retrieve 504 a vector image from the device that is the target of the image request, and then 2) display 506 the vector image to a user. The program 500 also comprises code 508 to correlate 1) a received handle representing a portion of the device (e.g., a handle provided by a user or device management tool) to 2) one or more vectors that are associated with the handle within the vector image. In response to an action associated with the received handle, additional code 510 then formats the vector image displayed to the user. The action associated with the received handle may take various forms, and in some cases may specify emphasizing vectors associated with the received handle (e.g., highlighting or bolding them) or deemphasizing vectors that are not associated with the received handle (e.g., graying out or hiding them). In some cases, the program 500 may be initiated in response to events such as: a paper jam in a printer, or a partition crash in a cellular server system.

As with the program 400, the program 500 may be incorporated into a particular device management tool. In other cases, the program 500 may be maintained apart from any particular device management tool (e.g., within an image processing utility) and may be accessed by various device management tools. By way of example, the “utility” may take the form of an application or browser plug-in.

In some cases, each access of a vector image may be made by retrieving the image directly from the device in which it is stored. In other cases, the program 500 may comprise code to store a retrieved vector image in off-device storage. In this latter case, the code 508 to map coordinates of a user's interaction and return a handle may access the vector image stored in the off-device storage.

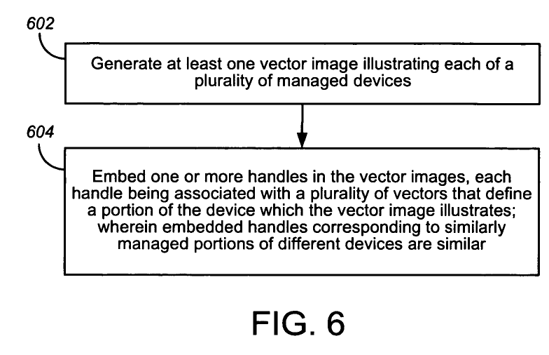

FIG. 6 illustrates an exemplary method 600 for generating images of managed devices. The method 600 comprises generating 602 at least one vector image illustrating each of the managed devices. For example, images of a plurality of different computer servers may be generated. In some cases, the images may appear vastly different, although each may have similar components, such as memory, processors, fans, and network interfaces. The method 600 then continues with the embedding 604 of one or more handles in the vector images, with each handle being associated with a plurality of vectors that define a portion of the device which the vector image illustrates. Embedded handles corresponding to similarly managed portions of different devices are similar (and preferably the same). In this manner, a device management tool may be created to interact with all of the devices, even though they are visually very different.

One advantage that may be realized using the above methods and apparatus is that the images of a device may be changed greatly, or different devices may have similar functionality but very different images, and 1) management tools may interact with the images in the same way, and 2) the images may be easily updated. This can reduce the time and cost of maintaining both the images and the device management tools.

What is claimed is:

1. A device, comprising:
a non-volatile memory in which a vector image illustrating at least a portion of the device is stored; wherein the vector image comprises a plurality of vectors; wherein one or more sets of the vectors are associated with one or more handles; and wherein each handle identifies a portion of the device; and
an interface to provide a remote management tool with access to the vector image, to assist the tool in managing the device.

2. The device of claim 1, wherein each of the handles is a unique identifier of a portion of the device.

3. The device of claim 2, wherein at least one of the handles comprises an address of a component of the device.

4. The device of claim 1, wherein the vector image is a Scalable Vector Graphics (SVG) image.

5. The device of claim 1, wherein the vector image is embodied in an extensible markup language (XML) format.

6. The device of claim 1, wherein the vector image is embodied in a postscript format.

7. A computer program, comprising:
code to, in response to receiving an image request,
retrieve a vector image from a device that is a target of the image request, the vector image illustrating at least a portion of the device; and
display the vector image to a user; and
code to, in response to the user's interaction with a portion of the displayed vector image,
map coordinates of the user's interaction to one or more vectors of the vector image; and
return a handle that i) is associated with the one or more vectors, and ii) identifies a portion of the device.

8. The computer program of claim 7, wherein the computer program is incorporated into a device management tool.

9. The computer program of claim 7, wherein:
the image request is received from a device management tool, and wherein the handle is returned to the device management tool; and
the computer program is incorporated into an image processing utility that stands apart from the device management tool.

10. The computer program of claim 7, wherein the vector image is a Scalable Vector Graphics (SVG) image.

11. The computer program of claim 7, further comprising code to, upon retrieving the vector image, store the vector image in an off-device storage; wherein the code to map coordinates of the user's interaction and return the handle accesses the vector image stored in the off-device storage.

12. The computer program of claim 7, wherein the handle is an address of a portion of the device.

13. A computer program, comprising:
code to, in response to receiving an image request,
retrieve a vector image from a device that is a target of the image request, the vector image illustrating at least a portion of the device; and
display the vector image to a user; and code to,
correlate i) a received handle representing a portion of the device to ii) one or more vectors that are associated with the handle within the vector image; and
in response to an action associated with the received handle, format the vector image displayed to the user.

14. The computer program of claim 13, wherein the action specifies emphasizing vectors associated with the received handle.

15. The computer program of claim 13, wherein the action specifies deemphasizing vectors not associated with the received handle.

16. The computer program of claim 13, wherein the computer program is incorporated into a device management tool.

17. The computer program of claim 13, wherein:
the image request is received from a device management tool; and
the computer program is incorporated into an image processing utility that stands apart from the device management tool.

18. The computer program of claim 13, wherein the vector image is a Scalable Vector Graphics (SVG) image.

19. The computer program of claim 13, further comprising code to, upon retrieving the vector image, store the vector image in an off-device storage; wherein the code to correlate the received handle and format the vector image accesses the vector image stored in the off-device storage.

20. The computer program of claim 13, wherein the handle is an address of a portion of the device.

21. An article of manufacture, comprising:
computer-readable media; and
computer-readable code, stored on the computer-readable media, including code to, in response to receiving an image request,
retrieve a vector image from a device that is a target of the image request, the vector image illustrating at least a portion of the device; and
display the vector image to a user; and code to,
correlate i) a received handle representing a portion of the device to ii) one or more vectors that are associated with the handle within the vector image; and
in response to an action associated with the received handle, format the vector image displayed to the user.

22. A method for generating images of managed devices, comprising:
generating at least one vector image illustrating each of the managed devices; and
embedding one or more handles in the vector images, each handle being associated with a plurality of vectors that define a portion of the device which the vector image illustrates;
wherein embedded handles corresponding to similarly managed portions of different devices are similar.

23. The method of claim 22, wherein embedded handles corresponding to similarly managed portions of different devices are the same.
